(19) United States
(12) Patent Application Publication
(10) Pub. No.: US 2024/0412692 A1
(43) Pub. Date: Dec. 12, 2024

(54) DISPLAY PANEL AND DISPLAY DEVICE

(71) Applicant: Xiamen Tianma Display Technology Co., Ltd., Xiamen (CN)

(72) Inventor: Qingjun LAI, Xiamen Fujian (CN)

(73) Assignee: Xiamen Tianma Display Technology Co., Ltd., Xiamen (CN)

(21) Appl. No.: 18/807,430

(22) Filed: Aug. 16, 2024

(30) Foreign Application Priority Data
Aug. 30, 2023 (CN) 202311103927.3

(51) Int. Cl. G09G 3/3233

(52) U.S. Cl. CPC G09G 3/3233; G09G 2310/04; G09G 2320/0233; G09G 2340/0435

(57) ABSTRACT

Provided is a display panel. A width W1 of a first data refresh region of the display panel working in a first stage is not equal to a width W2 of a first data refresh region of the display panel working in a second stage. In the conversion from the first stage to the second stage, the width of the first data refresh region is gradually reduced, and the second stage includes a second data refresh region with a refresh frequency different from a refresh frequency of the first data refresh region, so that the display panel can satisfy different display requirements simultaneously.

### CROSS-REFERENCE TO RELATED APPLICATION(S)

This application claims priority to Chinese Patent Application No. 202311103927.3 filed Aug. 30, 2023, the disclosure of which is incorporated herein by reference in its entirety.

### TECHNICAL FIELD

The present application relates to the field of display technologies and, in particular, to a display panel and a display device.

### BACKGROUND

With the development of organic light-emitting diodes (OLEDs), the OLEDs are widely used in various fields due to their characteristics such as self-luminous pixels, high contrast, wide viewing angles, thinness, and low energy consumption. The OLED display screen is made of organic light-emitting diodes.

The current OLED display panel includes pixel circuits and driver circuits. The driver circuits provide various types of drive signals to the pixel circuits, and a problem of non-uniform brightness on the display panel exists.

### SUMMARY

In view of this, an embodiment of the present application provides a display panel and a display device, which can reduce the brightness difference generated by the display panel for achieving different display requirement functions, ensure the display effect of different display regions, and satisfy the diversified requirements of users.

One aspect of an embodiment of the present application provides a display panel. The display panel includes a first data refresh region, and a data refresh frequency of the first data refresh region is F1. A working process of the display panel includes a first stage and a second stage, a width of the first data refresh region in a first direction is W1 in the first stage, a width of the first data refresh region in the first direction is W2 in the second stage, and W1>W2. At least in the second stage, the display panel further includes a second data refresh region, a data refresh frequency of the second data refresh region is F2, the first data refresh region and the second data refresh region are arranged in the first direction, and F1≠F2.

Another aspect of an embodiment of the present application provides a display device including the display panel as described above.

### BRIEF DESCRIPTION OF DRAWINGS

In order to describe technical solutions in embodiments of the present application or in the related art more clearly, the drawings used for describing the embodiments or the related art will be briefly introduced below. Apparently, the drawings in the following description are merely some embodiments of the present application. For those of ordinary skill in the art, other drawings may also be obtained without creative labor according to these drawings.

The structures, proportions, sizes and the like shown in the drawings of the specification are merely for matching contents disclosed in the specification and for the purpose of understanding and reading the present application by those skilled in the art, and are not intended to limit the limitation conditions implemented by the present application; therefore, they are not of any technical significance. Any modifications of the structures, changes of the proportional relationships, or adjustments of the sizes should be fall within the scope covered by the technical contents disclosed by the present application without affecting the efficacy that can be produced by the present application and the purpose that can be achieved by the present application.

FIG. 1 shows a schematic diagram of a working of a display panel according to an embodiment of the present application;

FIG. 2 shows a schematic diagram of a pixel circuit and a driver circuit according to an embodiment of the present application;

FIG. 3 shows a schematic structural view of a pixel circuit according to an embodiment of the present application;

FIG. 4 shows a schematic diagram of a driver circuit and a data refresh region according to an embodiment of the present application;

FIG. 5 shows a schematic diagram of another driver circuit and another data refresh region according to an embodiment of the present application;

FIG. 6 shows a schematic diagram of a working of another display panel according to an embodiment of the present application;

FIG. 7 shows a schematic diagram of a change of a width of a first data refresh region according to an embodiment of the present application;

FIG. 8 shows a schematic diagram of a width cycle process of a first data refresh region according to an embodiment of the present application; and

FIG. 9 shows a schematic structural view of a display device according to an embodiment of the present application.

### DETAILED DESCRIPTION

Features of various aspects and exemplary embodiments of the present application will be described in detail below, and in order to make objectives, technical solutions and advantages of the present application more apparent, the present application will be described in further detail below with reference to the accompanying drawings and specific embodiments. It is to be understood that the specific embodiments described herein are only intended to illustrate the present application, and are not intended to limit the present application. It will be apparent to those skilled in the art that the present application may be practiced without some details of these specific details. The following description of the embodiments is merely intended to provide a better understanding of the present application by illustrating examples of the present application.

It is to be noted that, in this specification, relational terms such as first and second are only used to distinguish one entity or operation from another entity or operation, and do not require or imply any actual relationship or sequence between these entities or operations. Furthermore, the terms “include”, “contain”, or any other variant thereof are intended to cover a non-exclusive inclusion, so that a process, a method, an article, or a device that includes a series of elements not only includes those elements, but also includes other elements that are not explicitly listed, or further includes elements inherent to the process, the method, the article, or the device. An element defined by the sentence “include . . . ” does not exclude that another same element exists in a process, a method, an article, or a device that includes the element, without more limitation.

It should be noted that embodiments of the present application and features of the embodiments may be combined with each other without conflict.

As described in the background art, the current display panel of the OLEDs includes the pixel circuit and the driver circuit. The driver circuit provides various types of drive signals to the pixel circuit, and two states, i.e., a refresh state and a retention state, are implemented within one frame of the display panel. The existence of a transverse mura on the display panel means that the brightness of the display panel is not uniform, thereby resulting in non-uniform color difference on the display panel.

Based on the above-described technical problems, embodiments of the present application provide a display panel and a display device. The display panel includes a first data refresh region, and a data refresh frequency of the first data refresh region is F1. A working process of the display panel includes a first stage and a second stage. A width of the first data refresh region in a first direction is W1 in the first stage, a width of the first data refresh region in the first direction is W2 in the second stage, and W1>W2. At least in the second stage, the display panel further includes a second data refresh region, a data refresh frequency of the second data refresh region is F2, the first data refresh region and the second data refresh region are arranged in the first direction, and F1≠F2. The width of the first data refresh region of the display panel working in the first stage is not equal to the width of the first data refresh region of the display panel working in the second stage, the width of the first data refresh region in the second stage is gradually reduced, and the second stage includes a second data refresh region with a refresh frequency different from the refresh frequency of the first data refresh region, so that the display panel can satisfy different display requirements simultaneously. The brightness difference generated by the display panel for achieving different display requirement functions is reduced by adjusting the width and the refresh frequency of the data refresh region of the display panel working in different stages, so that the display effect of different display regions can be ensured, and the diversified requirements of users can be satisfied.

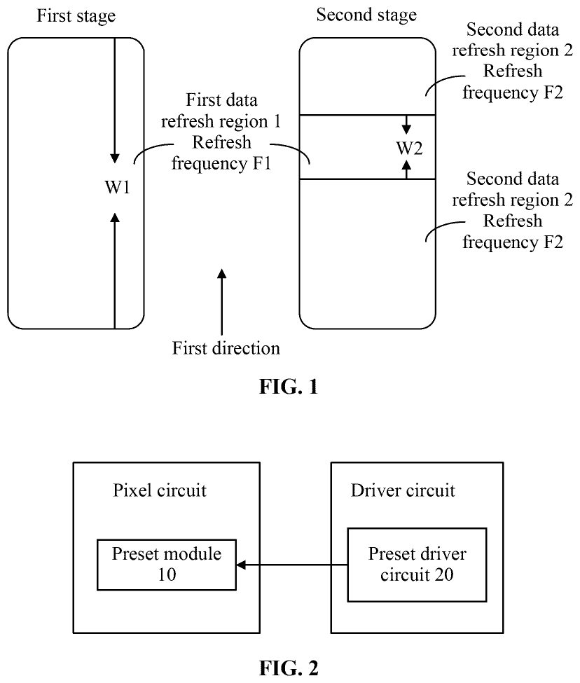

Referring to FIG. 1, FIG. 1 is a schematic diagram of a working of a display panel according to an embodiment of the present application. A working process of the display panel includes a first stage and a second stage, and the first stage in which the entire panel of the display panel works is used as an example. A width of a first data refresh region 1 in a first direction is W1 in the first stage, and a width of the first data refresh region 1 in the first direction is W2 in the second stage, and W1>W2. At least in the second stage, the display panel further includes a second data refresh region 2. The first data refresh region 1 and the second data refresh region 2 are arranged in the first direction. A data refresh frequency of the first data refresh region 1 is F1, and a data refresh frequency of the second data refresh region 2 is F2, and F1≠F2.

It is to be noted that the first stage is an initial stage, and the second stage is a target stage. Specific values of W1, W2, F1 and F2 are not limited in the embodiments of the present application, and the above-described parameters may be determined according to practical requirements.

In the embodiments of the present application, the display panel has one or more data refresh regions in different working processes. For example, the display panel includes the first data refresh region in the first stage, the display panel includes the first data refresh region and the second data refresh region in the second stage, and the data refresh frequency of the first data refresh region is different from the data refresh frequency of the second data refresh region. The number of data refresh regions and the specific arrangement position of the data refresh region on the display panel are not limited in the embodiments of the present application.

The working process of the display panel in the embodiments of the present application includes multiple stages, for example, the working process of the display panel includes the first stage and the second stage. For different stages, the display panel may use data refresh regions of different widths. For example, the display panel has a relatively large width in the data refresh region of the initial stage, and the display panel has a gradually reduced width in the data refresh region of the subsequent stage, to reduce the brightness difference generated by the display panel for achieving different functions. In the embodiments of the present application, other stages included in the working process of the display panel should be determined according to practical application scenarios. In some other embodiments of the present application, the working process of the display panel further includes a third stage, a fourth stage, and the like.

The working state of the display panel may be switched between the first stage and the second stage to implement the dynamic refresh. The width of the first data refresh region 1 of the first stage is longer than the width of the first data refresh region 1 of the second stage, the width of the first data refresh region 1 gradually decreases, and the second stage includes the second data refresh region 2. The data refresh frequency of the second data refresh region 2 is different from the data refresh frequency of the first data refresh region 1, so that the display panel can simultaneously satisfy various display requirements of users in different data refresh regions.

In a possible manner, referring to FIG. 2, FIG. 2 is a schematic diagram of a pixel circuit and a driver circuit according to an embodiment of the present application.

The display panel includes the pixel circuit and the driver circuit. The pixel circuit includes a preset module 10 on a data signal input path. A control terminal of the preset module 10 receives a preset control signal. When the preset control signal controls the preset module 10 to be turned on, a data refresh is performed on the pixel circuit. The driver circuit includes a preset driver circuit 20, and the preset driver circuit 20 is configured to provide the preset control signal to the control terminal of the preset module 10.

The pixel circuit provided in the embodiments of the present application includes one or more preset modules. For circuits of different functions, function circuits of the preset module are different and need to be determined according to application scenarios. Similarly, the driver circuit provided in the embodiments of the present application includes one or more preset driver circuits, and the preset driver circuit may be determined according to a type of the preset control signal that needs to be provided.

The pixel circuit and the light-emitting element are arranged in the display region of the display panel in an array manner, and the driver circuit is placed in a non-display region of the display panel. The driver circuit is configured to provide a control signal for each row of pixel circuits. The pixel circuit implements the data refresh based on the control signal. The specific process of generating the control signal by the driver circuit in the embodiments of the present application is not described in detail.

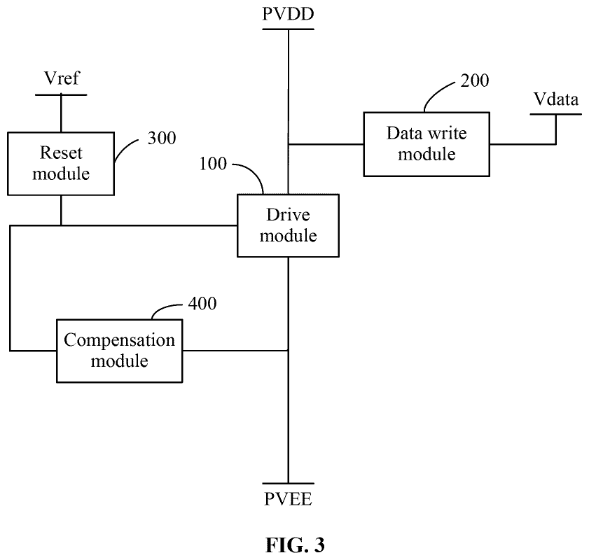

In some embodiments of the present application, the pixel circuit is further described. Referring to FIG. 3, the pixel circuit includes a drive module 100, a data write module 200, a reset module 300, and a compensation module 400. The data write module 200 is connected to a first terminal of the drive module 100 to provide a data signal to the drive module 100. The reset module 300 is connected to a control terminal of the drive module 100 to provide a reset signal to the drive module 100. The compensation module 400 is connected between a second terminal of the drive module 100 and the control terminal of the drive module 100. The preset module 10 described above is any one of the data write module 200, the reset module 300, or the compensation module 400, which is not limited in the embodiments of the present application.

Further, the compensation module 400 may be configured to compensate for a threshold voltage of the drive module 100 so that the drive current generated by the drive module 100 is not affected by the threshold voltage of the drive module 100, thereby improving the display uniformity of the display panel.

According to the embodiments of the present application, the data signal input path is as follows in the working process of the pixel circuit: a data signal Vdata is input into the drive module 100 via the data write module 200, and then reaches the reset module 300 via the compensation module 400, to complete the display of regions with different data refresh frequencies in the display panel.

It is to be noted that the pixel circuit further includes a light-emitting element, and the light-emitting element is not shown in FIG. 3. The drive module and the light-emitting element are connected in series between a first power signal PVDD and a second power signal PVEE, and a potential difference exists between the first power signal PVDD and the second power signal PVEE so that a drive current that drives the light-emitting element to perform the light emission may be generated.

The light-emitting element performs the light-emitting display in a frame-by-frame manner. Each frame includes a pre-stage and a light-emitting stage. The pre-stage is a non-light-emitting stage, and a corresponding control signal is prepared for the light-emitting stage. After each light emission is performed, the data signal Vdata is reset by the reset signal Vref to enter the pre-stage of a next frame. Whether the light-emitting element performs the light emission is controlled by an Emit signal, and the Emit signal may be a pulse signal. When the Emit signal is an effective pulse signal, the light-emitting element enters the light-emitting stage.

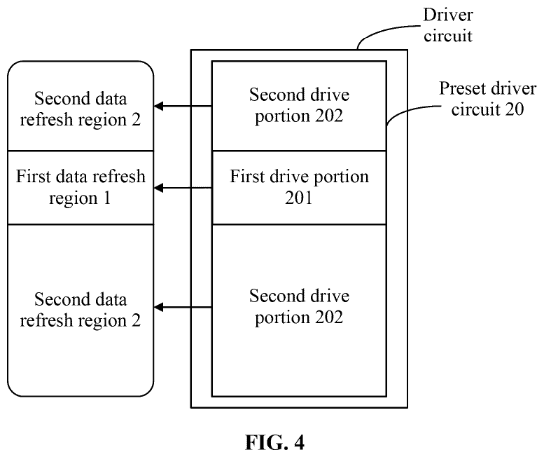

In a possible manner, referring to FIG. 4, FIG. 4 is a schematic diagram of a driver circuit and a data refresh region according to the embodiments of the present application. The display panel works in the first stage and the second stage separately, and the first stage and the second stage correspond to different data refresh frequencies. The data refresh frequency is controlled by the preset module 10, and the control signal of the preset module is provided by the driver circuit, that is, different data refresh regions are provided with control signals by different preset driver circuits. Specifically, the preset driver circuit 20 includes a first drive portion 201 and a second drive portion 202. The preset control signal includes a first preset control signal and a second preset control signal. The first drive portion 201 provides the first preset control signal to the first data refresh region 1. The second drive portion 202 provides the second preset control signal to the second data refresh region 2. The number of drive portions and the specific arrangement position of the data refresh region on the display panel are not limited in the embodiment of the present application.

The description is made by using an example in which the data refresh frequency of the first data refresh region 1 is 120 Hz and the data refresh frequency of the second data refresh region 2 is 1 Hz. In the first data refresh region 1 with the data refresh frequency of 120 Hz, control signals of 120 frames are all effective pulses. In the second data refresh region 2 of 1 Hz, a control signal of 1 frame is an effective pulse, and control signals of 119 frames are ineffective pulses. In a certain time period, the first preset control signal input to the pixel circuit by the first drive portion 201 is the effective pulse, and the preset module 10 is in an on state, so that the first data refresh region 1 has a refresh frequency of 120 Hz; the second preset control signal input to the pixel circuit by the second drive portion 202 is an ineffective pulse, and the preset module 10 is in an off state, so that the second data refresh region 2 has a refresh frequency of 1 Hz. Different control signals can control the data refresh region to be in different data refresh frequencies to present different display effects.

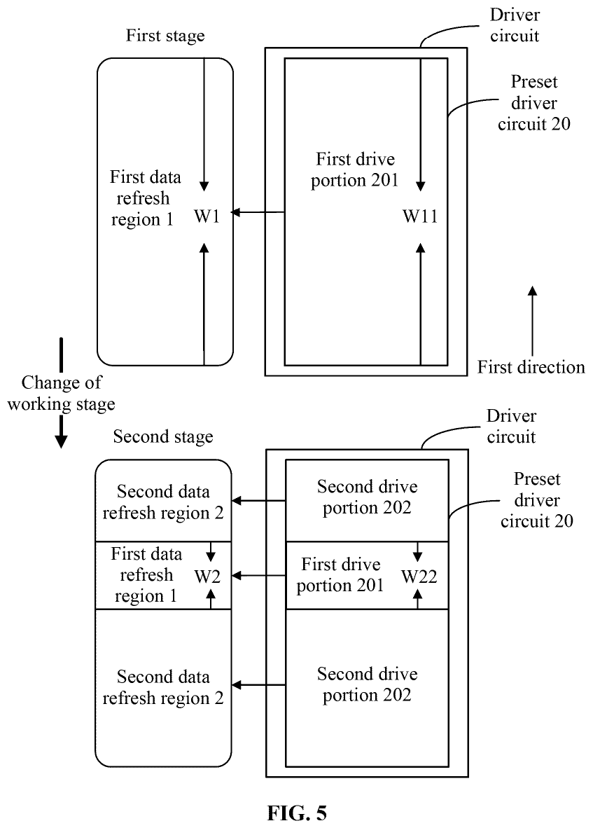

In a possible manner, the drive portion is configured to provide the control signal to the data refresh region, the width of the data refresh region changes, and correspondingly, the width of the drive portion for controlling the data refresh region in the first direction also changes in an equal proportion. Referring to FIG. 5, FIG. 5 is a schematic diagram of another driver circuit and another data refresh region according to an embodiment of the present application. In the first stage, the first drive portion 201 provides the first preset control signal to the first data refresh region 1 with the width of W1, and a width of the first drive portion 201 in the first direction is W11. In the second stage, the first drive portion 201 provides the control signal to the first data refresh region 1 with the width of W2, the width of the first drive portion 201 in the first direction is W22, and W11>W22.

It is to be noted that specific values of W11 and W22 are not limited in the embodiments of the present application, and the width of the drive portion may be correspondingly set according to a width of an actual data refresh region.

In a possible implementation, in at least part of a time period during which the display panel operates, the first preset control signal is different form the second preset control signal.

In different working stages, control signals for controlling different data refresh regions may be different signals. For example, at a 30th frame, the first preset control signal of the first data refresh region 1 is the effective pulse, so that the first data refresh region 1 is refreshed at a frequency of 120 Hz; the second preset control signal of the second data refresh region 2 is the ineffective pulse, so that the second data refresh region 2 is refreshed at a frequency of 1 Hz. That is, the first preset control signal of the first data refresh region 1 is different from the second preset control signal of the second data refresh region 2, to satisfy the display requirements of users.

In a possible implementation, F1>F2, in at least part of a time period during which the display panel operates, the first preset control signal controls the preset module 10 in the first data refresh region 1 to be turned on, and the second preset control signal controls the preset module 10 in the second data refresh region 2 to be turned off. It can be seen that the display requirements of users is to divide a low refresh frequency region from a high refresh frequency region. When different display requirements are satisfied, the second data refresh region 2 is refreshed at a lower frequency, thereby reducing the display energy consumption.

Alternatively, F1<F2, in at least part of a time period during which the display panel operates, the first preset control signal controls the preset module 10 in the first data refresh region 1 to be turned off, and the second preset control signal controls the preset module 10 in the second data refresh region 2 to be turned on. It can be seen that the display requirements of users is to divide a high refresh frequency region from a low refresh frequency region, and only the second data refresh region 2 is refreshed at a larger frequency, so that the unnecessary display energy consumption can be avoided while different display requirements are satisfied.

Description is made by using the above-described same example, in a high refresh frequency region of 120 Hz, the preset module 10 is in the on state. In a low refresh frequency region of 1 Hz, the preset module 10 is in the on state only in a preset time period and is in the off state in other time periods.

Based on the display panel described above, the display panel works at different stages, and widths of different data refresh regions may change based on the display requirements of users. The working process of the display panel includes the first stage and the second stage. The width W1 of the first data refresh region in the first direction in the first stage is longer than the width W2 of the first data refresh region in the first direction in the second stage, and the data refresh frequency of the first data refresh region is F1. At least in the second stage, the display panel further includes the second data refresh region with the data refresh frequency of F2, F1/F2, and the first data refresh region and the second data refresh region are arranged in the first direction. The width and the refresh frequency of the data refresh regions of the display panel working in different stages are adjusted to satisfy different display requirements and reduce the brightness differences generated by the display panel to implement different functions, thereby ensuring the display effect of different display regions and satisfying the diversified requirements of users.

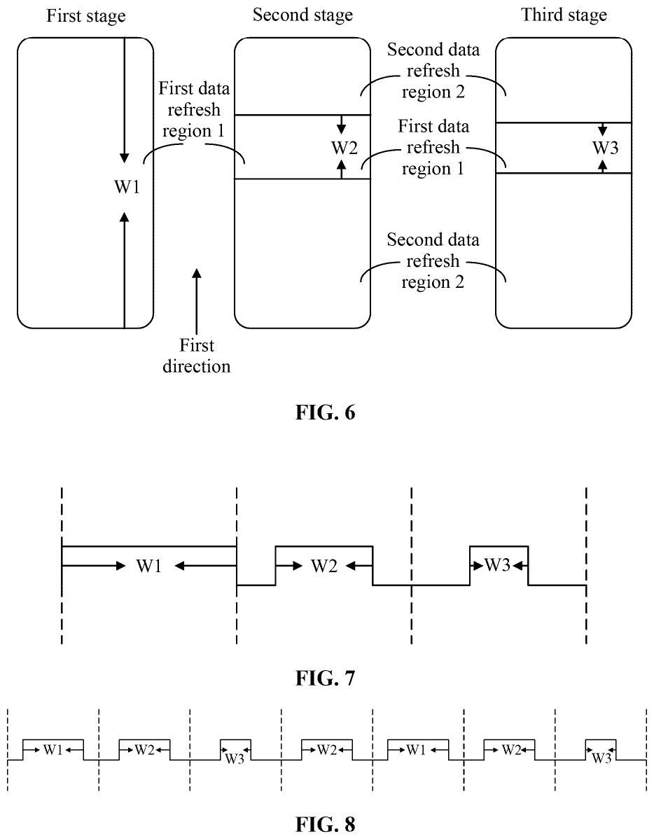

In another embodiment of the present application, referring to FIG. 6, FIG. 6 is a schematic diagram of a working of another display panel according to an embodiment of the present application. The working process of the display panel further includes a third stage. In the third stage, a width of the first data refresh region in the first direction is W3, and W3<W2.

For example, the working process of the display panel includes the first stage, the second stage and the third stage. The first stage is an initial stage, the second stage is a transition stage, and the third stage is a target stage. In the embodiments of the present application, at least one transition stage is introduced, the at least one transition stage is used for weakening a degree of a mura, and the mura is a phenomenon that various traces are caused due to the non-uniform brightness of the display panel.

When the display panel works, if the display panel is switched from the first stage to the third stage, then the degree of the mura is relatively heavy, and the brightness difference of the display panel brightness is large. The second stage (that is, the transition stage) is disposed between the first stage and the third stage, and the gradual switching of the first stage, the second stage and the third stage can weaken the degree of the mura and reduce the brightness difference of the display panel.

Referring to FIG. 7, the first stage in which the entire display panel works at the same refresh frequency is used as an example. FIG. 7 is a schematic diagram of a change of a width of a first data refresh region according to an embodiment of the present application. In the first stage, part of the display panel may work at one data refresh frequency and another part of the display panel may work at another data refresh frequency. The drawings are merely exemplary, and are not intended to limit the embodiments of the present application. In a possible implementation, the width of the first data refresh region may vary in an arithmetic manner, that is, W1−W2=W2−W3. For example, the width of the first data refresh region in the first stage is 50 mm, the width of the first data refresh region in the second stage is 40 mm, and the width of the first data refresh region in the third stage is 30 mm, which are merely examples and do not limit the width of the first data refresh region in the embodiments of the present application.

Each change of the first data refresh region is a progressive decrease or an incremental increase, the manner of achieving the arithmetic change in the width is relatively simple, the degree of the mura of the first stage is equivalent to the degree of the mura of the second stage, and the degrees of the mura of the second stage is equivalent to the degree of the mura of the third stage, so that the experience of using the display panel by users can be improved.

In a possible implementation, the width of the first data refresh region may also change in a non-arithmetic manner, that is, W1−W2≠W2−W3. The change of the width in the non-arithmetic manner can adaptively adjust their respective amplitudes of change sequentially for data refresh regions of different sizes. An adjustment amplitude of a data refresh region with a larger width is larger, and an adjustment amplitude of a data refresh region with a smaller width is smaller, so that the data refresh region can be adjusted to rapidly satisfy the display requirements of users.

In a possible implementation, W1−W2>W2−W3 or W1−W2<W2−W3.

In the embodiments of the present application, a difference between the width of the first data refresh region of the first stage and the width of the data refresh region of the second stage may be longer than a difference between the width of the first data refresh region of the second stage and the width of the data refresh region of the third stage, that is, an amplitude of change from the first stage to the second stage is longer than an amplitude of change from the second stage to the third stage. As described above, the entire display panel works at the same refresh frequency in the first stage, in order to ensure different display requirements of the display panel, the width of the first data refresh region is greatly reduced from the first stage to the second stage.

In the embodiments of the present application, a difference between the width of the first data refresh region of the first stage and the width of the data refresh region of the second stage may be less than a difference between the width of the first data refresh region of the second stage and the width of the data refresh region of the third stage, that is, an amplitude of change from the first stage to the second stage is less than an amplitude of change from the second stage to the third stage. As described above, the entire display panel works at the same refresh frequency in the first stage, the width of the first data refresh region may be reduced marginally from the first stage to the second stage, and the width of the first data refresh region may be greatly reduced from the second stage to the third stage, to ensure different display requirements of the display panel.

It is to be noted that if the display panel works in a data refresh region with a smaller width in the first stage and the display requirements of users are to expand the data refresh region, then the width of the first data refresh region may be greatly increased from the first stage to the second stage.

In a possible implementation, a duration of the first stage is longer than a duration of the second stage, and/or a duration of the third stage is longer than a duration of the second stage.

The second stage is the transition stage, and the first stage or the third stage is a stage that needs to be displayed on the display panel. The transition stage can satisfy the transition requirement, and a duration of the transition stage is relatively short. The duration of the transition stage is not limited in the embodiments of the present application and may be selected according to practical requirements.

Referring to FIG. 8, FIG. 8 is a schematic diagram of a width cycle process of a first data refresh region according to an embodiment of the present application. The first stage in which part of the display panel works at one data refresh frequency and another part of the display panel works at multiple other data refresh frequencies is used as an example, the working process of the display panel includes the transition stage, in the transition stage, at least two of the first stage, the second stage and the third stage are stages in which a repeating unit repeats a cycle at least once. In this embodiment, the initial stage is the working stage of the entire display panel, the first stage and the second stage are each the transition stage, the third stage is the target stage, the target stage and the transition stage are continuously switched by using the cyclic transition method, and thus the degree of the mura is weakened.

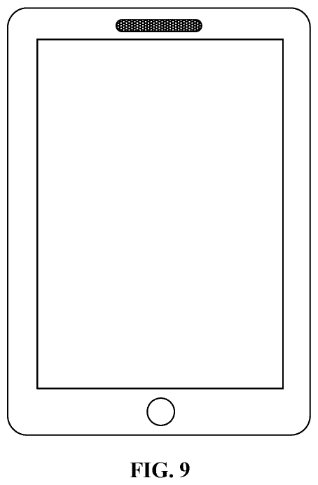

Based on the display panel provided in the above-described embodiments, embodiments of the present application further provide a display device. Referring to FIG. 9, the embodiments of the present application further provide a display device. The display device may include the display panel described in any one of FIG. 1 to FIG. 8.

The function blocks shown in the above-described structural block diagrams may be implemented as hardware, software, firmware, or a combination thereof. When the function blocks are implemented in a hardware manner, the function blocks may be, such as, an electronic circuit, an application specific integrated circuit (ASIC), a suitable firmware, plug-in, function card, and the like.

The principle and embodiments of the present application are described herein by using specific examples, and the description of the above examples is only used to help understanding the device of the present application and the core idea of the present application. The above embodiments are only preferred embodiments of the present application. It is to be noted that an infinite specific structure exists objectively due to the limited character expression, some improvements, modifications or changes may also be made by those of ordinary skill in the art without departing from the principle of the present application, and the above-described technical features may also be combined in an appropriate manner. These modifications, variations or combinations, or no modification, directly apply the concept and technical solution of the present application to other occasions, should all belong to the scope of protection of the present application.

What is claimed is:

1. A display panel, comprising:
a first data refresh region, wherein a data refresh frequency of the first data refresh region is F1;
wherein a working process of the display panel comprises a first stage and a second stage; in the first stage, a width of the first data refresh region in a first direction is W1; in the second stage, the width of the first data refresh region in the first direction is W2; and W1>W2; and
wherein at least in the second stage, the display panel further comprises a second data refresh region, a data refresh frequency of the second data refresh region is F2, the first data refresh region and the second data refresh region are arranged in the first direction, and F1≠F2.

2. The display panel of claim 1, wherein:
the display panel comprises a pixel circuit and a driver circuit;
the pixel circuit comprises a preset module in a data signal input path, a control terminal of the preset module is configured to receive a preset control signal, and when the preset control signal controls the preset module to be turned on, a data refresh is performed on the pixel circuit; and
the driver circuit comprises a preset driver circuit, and the preset driver circuit is configured to provide the preset control signal to the control terminal of the preset module.

3. The display panel of claim 2, wherein the pixel circuit comprises a drive module, a data write module, a reset module and a compensation module,
wherein the data write module is connected to a first terminal of the drive module and is configured to provide a data signal to the drive module;
the reset module is connected to a control terminal of the drive module and is configured to provide a reset signal to the drive module;
the compensation module is connected between a second terminal of the drive module and the control terminal of the drive module; and
the preset module is one of the data write module, the reset module, or the compensation module.

4. The display panel of claim 2, wherein:
the preset driver circuit comprises a first drive portion and a second drive portion;
the preset control signal comprises a first preset control signal and a second preset control signal;
the first drive portion is configured to provide the first preset control signal to the first data refresh region; and
the second drive portion is configured to provide the second preset control signal to the second data refresh region.

5. The display panel of claim 4, wherein:
in the first stage, a width of the first drive portion in the first direction is W11; and
in the second stage, a width of the first drive portion in the first direction is W22, and W11>W22.

6. The display panel of claim 4, wherein:
in at least part of a time period during which the display panel operates, the first preset control signal is different from the second preset control signal.

7. The display panel of claim 6, wherein:
F1>F2, in the at least part of the time period during which the display panel operates, the first preset control signal controls the preset module in the first data refresh region to be turned on, and the second preset control signal controls the preset module in the second data refresh region to be turned off; or
F1<F2, in the at least part of the time period during which the display panel operates, the first preset control signal controls the preset module in the first data refresh region to be turned off, and the second preset control signal controls the preset module in the second data refresh region to be turned on.

8. The display panel of claim 1, wherein:
the working process of the display panel further comprises a third stage, in the third stage, a width of the first data refresh region in the first direction is W3, and W3<W2.

9. The display panel of claim 8, wherein W1−W2=W2−W3.

10. The display panel of claim 8, wherein W1−W2≠W2−W3.

11. The display panel of claim 10, wherein W1−W2>W2−W3, or W1−W2<W2−W3.

12. The display panel of claim 8, wherein at least one of the following is satisfied:
a duration of the first stage is longer than a duration of the second stage; or
a duration of the third stage is longer than a duration of the second stage.

13. The display panel of claim 8, wherein:
the working process of the display panel comprises a transition stage; and
in the transition stage, at least two of the first stage, the second stage and the third stage are repeated units and are repeated at least once.

14. A display device, comprising a display panel,
wherein the display panel comprises:
a first data refresh region, wherein a data refresh frequency of the first data refresh region is F1;
wherein a working process of the display panel comprises a first stage and a second stage; in the first stage, a width of the first data refresh region in a first direction is W1; in the second stage, the width of the first data refresh region in the first direction is W2; and W1>W2; and
wherein at least in the second stage, the display panel further comprises a second data refresh region, a data refresh frequency of the second data refresh region is F2, the first data refresh region and the second data refresh region are arranged in the first direction, and F1≠F2.
